(19) United States
(12) Patent Application Publication
(10) Pub. No.: US 2006/0017368 A1
(43) Pub. Date: Jan. 26, 2006

(54) Transparent light-emitting conductive layer and electron emission device including transparent light-emitting conductive layer

(76) Inventors: Jae-Woo Bae, Suwon-si (KR); Do-Hyung Park, Suwon-si (KR); Byung-Tae Ahn, Daejeon (KR)

Correspondence Address: Robert E. Bushnell, Suite 300, 1522 K Street, N.W., Washington, DC, 20005, US

(21) Appl. No.: 11/182,788

(22) Filed: Jul. 18, 2005

(30) Foreign Application Priority Data
Jul. 20, 2004 (KR) 10-2004-0056416

(51) Int. Cl. H01J 1/62; H01J 63/04

(52) U.S. Cl. 313/491; 313/495

(57) ABSTRACT

A transparent light-emitting conductive layer includes a Transparent Conductive Oxide (TCO) and a dopant. An electron emission device having the transparent light-emitting conductive layer includes: a front substrate; a first electrode arranged on the front surface, the first electrode having a transparent light-emitting conductive layer including a Transparent Conductive Oxide (TCO) and a dopant; a fluorescent layer arranged on the first electrode; a rear substrate spaced apart from and facing the front substrate; an electron emission region arranged on the rear substrate; and a second electrode adapted to control electron emission in the electron emission region. The electron emission device can be used as an electron emission display device or a back-light unit. The transparent light-emitting conductive layer induces additional light emission using excess electrons that did not participate in the light emission in a fluorescent layer and thus results in improvements in color purity, reproduction range of colors, brightness, and color rendering properties when used in a device.

### CLAIM OF PRIORITY

This application makes reference to, incorporates the same herein, and claims all benefits accruing under 35 U.S.C. § 119 from an application for TRANSPARENT LIGHT-EMITTING CONDUCTIVE LAYER AND ELECTRON EMISSION DEVICE COMPRISING THE SAME earlier filed in the Korean Intellectual Property Office on the 20 of Jul., 2004 and there duly assigned Serial No. 10-2004-0056416.

### BACKGROUND OF THE INVENTION

1. Field of the Invention

The present invention relates to a transparent light-emitting conductive layer and an electron emission device including the transparent light-emitting conductive layer. More particularly, the present invention relates to a transparent light-emitting conductive layer that can induce light emission using excess electrons that did not participate in the light emission in a fluorescent layer and an electron emission device including the transparent light-emitting conductive layer. The transparent light-emitting conductive layer can be used in various ways for an electron emission display device, a back-light unit, a flat display device including a back-light unit using the transparent light-emitting conductive layer, etc.

2. Description of the Related Art

In general, electron emission devices can be divided into two categories, that is, one type using a thermal cathode as an electron emission source and another type using a cold cathode as an electron emission source.

Examples of electron emission devices that use a cold cathode include a Field Emitter Array (FEA) device, a Surface Conduction Emitter (SCE) device, a Metal-Insulator-Metal (MIM) device, a Metal-Insulator-Semiconductor (MIS) device, and a Ballistic electron Surface Emitting (BSE) device, etc.

FEA devices are based on the principle that electrons are easily emitted due to a variation in electric field in a vacuum when a material having a low work function or high 13 function is used as an electron emission source. This type of device uses a tapered tip structure containing Mo, Is, etc. as a main component, a carbonaceous material, such as graphite, Diamond like Carbon (DLC), etc., or nano materials, such as nano-tubes or nano-wires, etc. as an electron emission source.

SCE devices have an electron emission region obtained by cracking a conductive thin film formed between a first electrode and a second electrode, which are disposed to face each other on a first electrode. This type of device is based on the principle that electrons are emitted from an electron emission region, which is a fine gap, as current is supplied to the surface of the conductive thin film.

In MIM and MIS electron emission devices, an electron emission region consisting of metal-dielectric layer-metal (MIM) and metal-dielectric layer-semiconductor (MIS) structure is formed. In these types of devices, electrons are emitted while moving and accelerating from a metal or semiconductor having a high electron potential to a metal having a low electron potential when a voltage is supplied between the two metals or the metal and semiconductor that that dielectric layer is intervening.

BSE devices are based on the principle that electrons move without scattering when the size of a semiconductor is reduced to be smaller than an average free path of the electrons of the semiconductor. An electron source layer consisting of metal or semiconductor is formed on an ohmic electrode, an insulating layer and a metal thin film formed on the electron source layer. Electrons are emitted from the device as a voltage is supplied across the ohmic electrode and the metal thin film.

Electrons that emitted from various electron emission regions as described above are radiated to a fluorescent layer disposed to face the electron emission region, thereby emitting light. Korean Patent Publication No. 2001-0036947 relates to an electron emission display device comprising a carbon nano-tube film, a dielectric layer, a gate electrode, an anode, and a fluorescent layer, wherein the anode is formed of a transparent conductive layer.

However, sufficient light emission efficiency cannot be achieved with the technology described above since excess electrons that are emitted from the electron emission region but did not participate in the light emission in a fluorescent layer are lost as heat or flow out through the conductive anode electrode. The lost of excess electrons as heat deteriorates the fluorescent layer. Therefore, there still is a need to improve the light emission efficiency of electron emission devices.

### SUMMARY OF THE INVENTION

The present invention provides a transparent light-emitting conductive layer and an electron emission device including the transparent light-emitting conductive layer. The electron emission device can be used as an electron emission display device or a back-light unit, etc.

The present invention also provides an electron emission display device including the electron emission device, a back-light unit using the transparent light-emitting conductive layer, and a flat display using the back-light unit.

According to one aspect of the present invention, a transparent light-emitting conductive layer comprising a transparent conductive oxide and a dopant is provided.

The TCO comprises a material selected from a group consisting of ZnO, SnO₂, In₂O₃, ZnGa₂O₄, CdSnO₃, and SrTiO₃.

The dopant is adapted to act as activator ions and comprises at least one material selected from a group consisting of Eu, Tb, Mn, Gd, Sm, Ho, Tm, Dy, Pr, Ce, Nd, Cu, Ag, and Mg.

The content of the dopant is in a range of 0.005-15 mole % based on the content of the TCO.

The transparent light-emitting conductive layer comprises deposited and then heated TCO doped with the dopant on a substrate.

The TCO is adapted to be heated by a furnace or rapid heating method.

The TCO is adapted to be heated at a temperature of 500-1200 C.°.

The TCO is adapted to be heated in a hydrogen atmosphere.

According to another aspect of the present invention, an electron emission device is provided comprising: a front substrate; a first electrode arranged on the front surface, the first electrode having a transparent light-emitting conductive layer including a Transparent Conductive Oxide (TCO) and a dopant; a fluorescent layer arranged on the first electrode; a rear substrate spaced apart from and facing the front substrate; an electron emission region arranged on the rear substrate; and a second electrode adapted to control electron emission in the electron emission region.

The TCO comprises a material selected from a group consisting of ZnO, SnO₂, In₂O₃, ZnGa₂O₄, CdSnO₃, and SrTiO₃.

The dopant is adapted to act as activator ions and comprises at least one material selected from a group consisting of Eu, Tb, Mn, Gd, Sm, Ho, Tm, Dy, Pr, Ce, Nd, Cu, Ag, and Mg.

The content of the dopant is in a range of 0.005-15 mole % based on the content of the TCO.

The electron emission region includes carbon nano-tubes.

The TCO comprises a material selected from a group consisting of ZnO, SnO₂, In₂O₃, ZnGa₂O₄, CdSnO₃, and SrTiO₃, and the dopant is adapted to act as activator ions and comprises at least one material selected from a group consisting of Eu, Tb, Mn, Gd, Sm, Ho, Tm, Dy, Pr, Ce, Nd, Cu, Ag, and Mg.

According to yet another aspect of the present invention, a back-light unit is provided comprising: a front substrate; a first electrode arranged on the front substrate; a fluorescent layer arranged on the first electrode, the first electrode having a transparent light-emitting conductive layer including a Transparent Conductive Oxide (TCO) and a dopant; a rear substrate spaced apart from and facing the front substrate; an electron emission region arranged on the rear substrate; and a second electrode adapted to control electron emission in the electron emission region.

According to still another aspect of the present invention, a flat display device is provided comprising: a back-light unit including: a front substrate; a first electrode arranged on the front substrate; a fluorescent layer arranged on the first electrode, the first electrode having a transparent light-emitting conductive layer including a Transparent Conductive Oxide (TCO) and a dopant; a rear substrate spaced apart from and facing the front substrate; an electron emission region arranged on the rear substrate; and a second electrode adapted to control electron emission in the electron emission region; and a display panel arranged in front of the back-light unit and including a light receiving device adapted to reproduce images by controlling the light emitted from the back-light unit.

In an electron emission device according to the present invention including the transparent light-emitting conductive layer described above, excess electrons, which remain and have not participated in the light emission in a fluorescent layer, can contribute to additional light emission due to the transparent light-emitting conductive layer, thereby resulting in improvements in color purity, reproduction range of colors, brightness, and color rendering properties. Using the transparent light-emitting conductive layer according to the present invention, an electron emission device, an electron emission display device, a back-light unit, or a flat display device using the back-light unit can be manufactured with improved light emission efficiency. In particular, when the transparent light-emitting conductive layer is used in a display device, the light emission characteristics of the transparent light-emitting conductive layer can be controlled using a dopant to improve color purity, reproduction range of colors, brightness, and color rendering properties.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a sectional view of an electron emission device according to an embodiment of the present invention;

FIG. 2 is a sectional view of an electron emission display device according to an embodiment of the present invention;

FIG. 3 is a sectional view of an electron emission display device according to another embodiment of the present invention;

FIG. 4 is a graph of light transmittance of a transparent light-emitting conductive layer according to an embodiment of the present invention and an ITO layer;

FIG. 5 is a graph of light transmittance of a transparent light-emitting conductive layer according to another embodiment of the present invention formed under different heat treatment conditions and an ITO layer;

FIG. 6 is a graph of photoluminescence of a material composing a transparent light-emitting conductive layer according to an embodiment of the present invention;

FIG. 7 is a graph of photoluminescence of a transparent light-emitting conductive layer according to an embodiment of the present invention;

FIG. 8 is a graph of cathodluminescence of a transparent light-emitting conductive layer according to an embodiment of the present invention; and

FIG. 9 is a graph of cathodluminescence of a transparent light-emitting conductive layer according to another embodiment of the present invention.

### DETAILED DESCRIPTION OF THE INVENTION

A transparent light-emitting conductive layer according to the present invention contains a Transparent Conductive Oxide (TCO) and a dopant. The TCO can be a material having a transmittance of 80% or greater in a visible light region to efficiently transmit light emitted from a fluorescent layer adjacent to the transparent light-emitting conductive layer. The TCO can be a material having an energy band gap of 3 eV or greater. Specific examples for the TCO include, but are not limited to, ZnO, SnO₂, In₂O₃, ZnGa₂O₄, CdSnO₃, SrTiO₃, etc. Among these materials, ZnO and SnO₂ are preferred. The TCO can improve the conductivity of the transparent light-emitting conductive layer.

The dopant in the transparent light-emitting conductive layer is activator ions and induces additional light emission using excess electrons that did not participate in the light emission in the fluorescent layer adjacent to the transparent light-emitting conductive layer. The dopant can be selected from, but is not limited to, the group consisting of Eu, Tb, Mn, Gd, Sm, Ho, Tm, Dy, Pr, Ce, Nd, Cu, Ag, and Mg according to the reproduction range of colors to be realized. A combination of at least two of the above-listed materials can be used if required. Among these materials, Eu and Mn are preferred.

Due to the transparent light-emitting conductive layer consisting of the TCO and the dopant, excess electrons which have reached the interface between the conductive layer and the fluorescent layer adjacent to the conductive layer but did not participate in the light emission can contribute to additional light emission rather than be lost as heat. In particular, when the transparent light-emitting conductive layer is used in a display device, the transparent light-emitting conductive layer enhances the light emission characteristics of the fluorescent layer, thereby greatly improving the color purity, reproduction range of colors, brightness, and color rendering properties of the display device.

The content of the dopant can be 0.005-15 mole %, preferably, 0.005-10 mole %, based on the content of the TCO. If the content of the dopant is lower than 0.005 mole % based on the content of the TCO, an additional light emission effect in a desired level does not occur. If the content of the dopant is greater than 15 mole % based on the content of the TCO, the light transmittance of the transparent light-emitting conductive layer is too low for a display device or a back-light unit. In particular, when Eu is used as the dopant, the content of Eu can be 0.005-15 mole %, preferably, 0.05-10 mole % based on the content of the TCO. When Mn or Tb is used as the dopant, the content of Mn or Tb can be 0.005-2 mole % based on the content of the TCO.

The transparent light-emitting conductive layer can be formed on a surface of a substrate made of, for example, glass through deposition and heating processes.

First, a pre-mixture for forming the transparent light-emitting conductive layer is prepared by mixing the TCO in powder form and a dopant-containing material and preheated. The preheating process can be generally carried out at a temperature of 1000-1600 C.° for 2-4 hrs. The conditions for the preheating process can be varied according to the characteristics of the TCO used and the dopant-containing material. The dopant-containing material can be an oxide of the dopant used in the present invention.

The pre-mixture is deposited on a surface of a substrate. The deposition process can be, but is not limited to, sputtering, electron beam deposition, etc. In particular, the sputtering can be rf sputtering using an argon plasma.

A thin film formed through the deposition is heated. This heating process can be performed using a furnace method, a rapid heating method, etc. However, the present invention is not limited to these methods. In particular, when using the rapid heating method, a Rapid Temperature Annealing (RTA) method can be used.

The heating process performed after the deposition can be performed at a temperature of 500-1200 C.°, preferably, 500-1100 C.°. The temperature of the heating process can be varied according to the TCO used. For example, when SnO₂ is used as the TCO, the heating process can be carried out at 600 C.°. When ZnO is used as the TCO, the heating process can be carried out at 1000-1100 C.°. If the temperature of the heating process is lower than 500 C.°, an anode electrode, which is the deposited transparent light-emitting conductive layer, is not strong enough. If the temperature of the heating process is greater than 1200 C.°, the material composting the transparent light-emitting conductive layer is oxidized, resulting in low conductivity. When using Corning glass (Dow Corning) or quartz as the substrate on which the transparent light-emitting conductive layer is deposited, it is preferable that the heating process following the deposition is performed at a low temperature.

The heating process following the deposition can be carried out in air or in a hydrogen atmosphere, with the hydrogen atmosphere being preferred. When the heating process is performed in a reduction atmosphere, such as the hydrogen atmosphere, the transmittance of the transparent light-emitting conductive layer is improved.

The transparent light-emitting conductive layer according to the present invention described above can be used in an electron emission device.

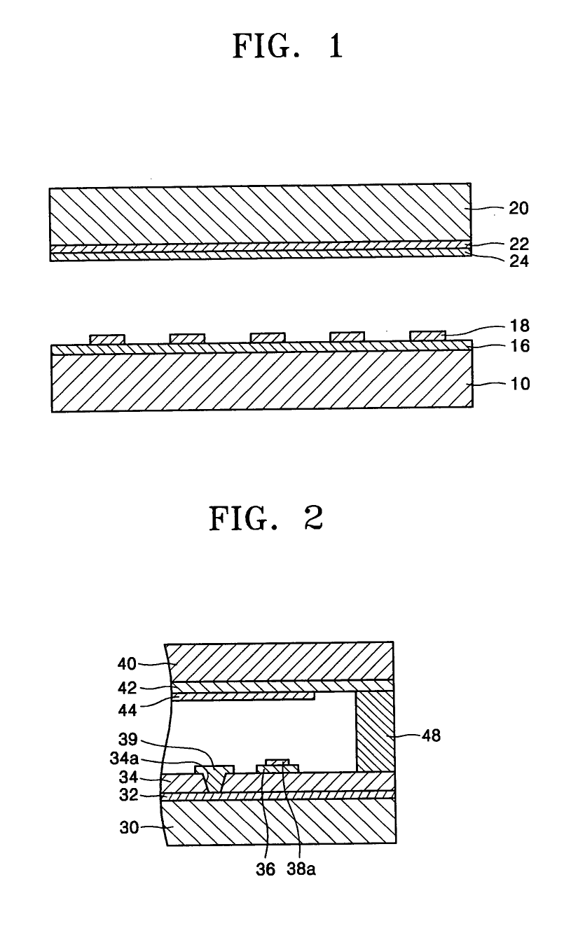

An embodiment of an electron emission device according to the present invention is described as follows with reference to FIG. 1. Referring to FIG. 1, a cathode electrode 16, which controls the emission of electrons in an electron emission region 18, is formed on a top surface of a rear substrate 10. The rear substrate 10 can be formed of, for example, glass. The cathode electrode 16 can be formed of, but is not limited to, a TCO, such as ITO, IZO, In₂O₃, etc., or a metal, such as Mo, Ni, Ti, Cr, W, Ag, etc. The cathode electrode 16 can be formed in various shapes, for example, as stripes, one integrated plate, etc.

The electron emission region 18 on the cathode electrode 16 can be formed in various shapes, for example, as an electron emission source in a structure with sharp tips mainly composed of, for example, Mo, Si, etc., an electron emission source composed of a carbonaceous material, an electron emission source using a conductive thin film with microcracks, an electron emission source with a metal/dielectric layer/metal structure or a metal-dielectric layer-semiconductor structure, etc. Examples of carbonaceous materials for the electron emission source can include, but is not limited to, carbon nano-tubes, Fullerene, Diamond-Like Carbon (DLC), etc.

A front substrate 20 is disposed to face the rear substrate 10 with a predetermined interval therebeween. The front substrate 20 can be made of, for example, glass, etc. An anode electrode 22 is formed on a lower surface of the front substrate 20 using deposition, which is described later. The material for the front substrate 20 can be selected in consideration of the temperature at which the anode electrode 22 is deposited thereon. The anode electrode 22 formed on the lower surface of the front substrate 20 is the transparent light-emitting conductive layer according to the present invention. A fluorescent layer 24 is formed on the anode electrode 22. As a predetermined voltage is supplied across the anode electrode 22 and the cathode electrode 16, electrons are emitted from the electron emission region 18 and collide against the fluorescent layer 24 to excite the fluorescent material of the fluorescent layer 24 and emit visible light.

The anode electrode 22 is the transparent light-emitting conductive layer according to the present invention containing a TCO and a dopant as described above. Accordingly, a detailed descriptions of the transparent light-emitting conductive layer has been omitted. Due to the anode electrode 22, which is the transparent light-emitting conductive layer according to the present invention, excess electrons which have reached the interface between the anode electrode and the fluorescent layer from the electron emission region 18 but did not participate in the light emission in the fluorescent layer 24 can contribute to additional light emission.

The present invention provides an electron emission display device having the transparent light-emitting conductive layer as described above.

FIG. 2 is a sectional view of an electron emission display device according to an embodiment of the present invention. Referring to FIG. 2, a gate electrode 32 is formed on a surface of a rear substrate 30, and an insulating layer 34 is formed on the gate electrode 32. A plurality of via holes 34a are formed in the insulating layer 34, and gate islands 39 filling the via holes 34a are formed in the insulating layer 34. The gate islands 39 are formed to enhance the effect of an electric field applied to the electron emission region 38a and facilitate the emission of electrons from the electron emission region 38a. The gate islands 39 can be formed of a conductive material and can be formed simultaneously with the cathode electrode 36. An anode electrode 42 is formed on a lower surface of a front substrate 40. The anode electrode 42 is the transparent light-emitting conductive layer described above. Accordingly, detailed descriptions of the transparent light-emitting conductive layer have been omitted. A fluorescent layer 44 is formed on the anode electrode 42, and a sealing member 48 is disposed between the front substrate 40 and the rear substrate 20.

When the transparent light-emitting conductive layer is used in a display device as described above, the transparent light-emitting conductive layer enhances the light emission characteristics of the fluorescent layer, thereby greatly improving the color purity, reproduction range of colors, brightness, and color rendering properties of the display device.

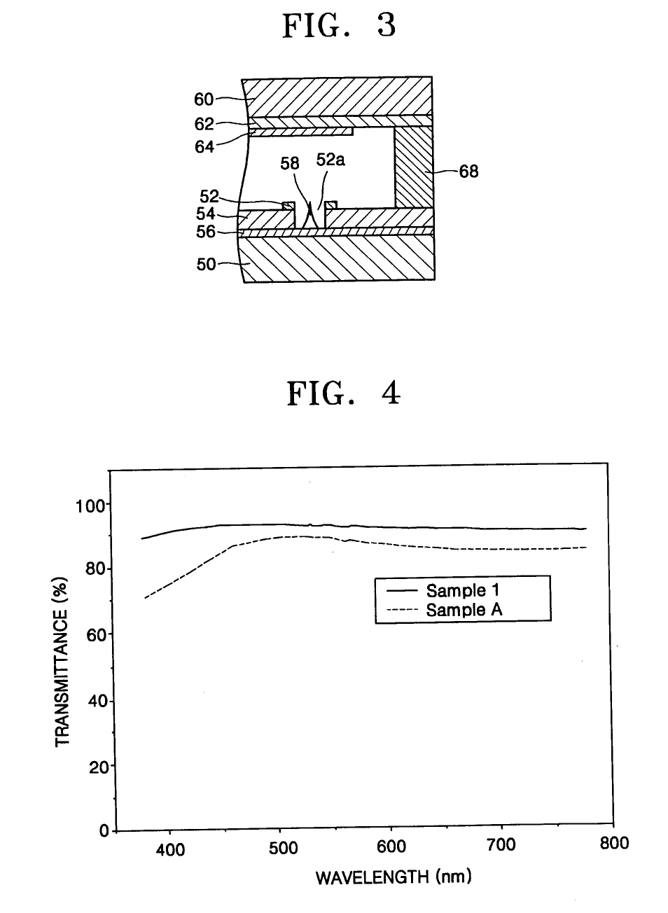

FIG. 3 is a sectional view of an electron emission display device according to another embodiment of the present invention including the transparent light-emitting conductive layer described above. Referring to FIG. 3, a cathode electrode 56 is formed on a rear substrate 50, and an insulating layer 54 is formed on the cathode electrode 56. A gate hole 52a is formed in the insulating layer 54, and an electron emission region 58 is formed in the gate hole 52a. Although the electron emission region 58 shown in FIG. 3 has a conical shape, the electron emission region can have any shape, and is not limited to the conical shape. A gate electrode 52 is formed on the insulating layer 54. An anode electrode 62 is formed on a lower surface of a front substrate 60. The anode electrode 62 is the transparent light-emitting conductive layer described above. Accordingly, detailed descriptions of the transparent light-emitting conductive layer have been omitted. A fluorescent layer 64 is formed on the anode electrode 62, and a sealing member 68 is disposed between the front substrate 60 and the rear substrate 50.

The electron emission display devices in FIGS. 2 and 3 according to the present invention described above are for illustrative purposes. Electron emission display devices according to the present invention can have various structures provided that they include the transparent light-emitting conductive layer described above.

The present invention provides a back-light unit including the transparent light-emitting conductive layer described above and a flat display device including the back-light unit.

A back-light unit according to the present invention can be an electron emission back-light unit with a flat emission structure. Electron emission type back-light units consume less power and provide more uniform brightness with a large emission area than back-light units using cold cathode fluorescent lamps, etc. When the transparent conductive phosphor described above is used in such an electron emission type back-light unit, the back-light unit according to the present invention can provide higher brightness than conventional back-light units.

The back-light unit according to the present invention can be used in a light receiving type flat display, which cannot spontaneously emit light to form images and form images using light input from an external source. For example, the back-light unit according to the present invention can be disposed in front of a light receiving type display panel, which reproduces images by controlling the light emitted from the back-light unit. An example of the flat display device includes a liquid crystal display.

The present invention will be described in grater detail with reference to the following examples. The following examples are for illustrative purposes and are not intended to limit the scope of the present invention.

### EXAMPLE 1

SnO₂ doped with 1 mole % of Eu₂O₃ was deposited on a glass substrate using rf sputtering with Ar plasma at 150 watt for 30 min. A resulting thin film was heated in air using RTA at 700 C.° for 1 hour to obtain a sample (“Sample 1”).

### EXAMPLE 2

A sample (“Sample 2”) was manufactured in the same manner as in Example 1, except that the heating was performed at 900 C.°.

### EXAMPLE 3

ZnO doped with 1 mole % of Mn was deposited on a glass substrate using rf sputtering with Ar plasma at 150 watt for 30 min. A resulting thin film was heated using RTA in a hydrogen atmosphere at a temperature of 1000-1100 C.° for 1 hour to obtain a sample (“Sample 3”).

### EXAMPLE 4

A sample (“Sample 4”) was manufactured in the same manner as in Example 3, except that the heating was performed in air.

### EXAMPLE 5

A sample (“Sample 5”) was manufactured in the same manner as in Example 3, except that Tb instead of Mn was used as the dopant.

### EXAMPLE 6

A sample (“Sample 6”) was manufactured in the same manner as in Example 3, except that In₂O₃ instead of ZnO was used as the transparent conductive material.

### EXAMPLE 7

A sample (“Sample 7”) was manufactured in the same manner as in Example 3, except that In₂O₃ instead of ZnO was used as the transparent conductive material and Tb instead of Mn was used as the dopant.

### COMPARATIVE EXAMPLE

A sample (“Sample A”) was manufactured in the same manner as in Example 2, except that ITO instead of SnO₂ and Eu₂O₃ was used.

### EVALUATION EXAMPLE 1

### Measurement of Transmittance

The transmittances of Samples 1, 3, 4, and A were measured using a UV-visible spectrometer in a visible range of 380-780 nm. The transmittances of Samples 1 and A are shown in FIG. 4. Referring to FIG. 4, the transmittance of Sample 1 according to the present invention is greater than the transmittance of Sample A over the entire range of wavelengths.

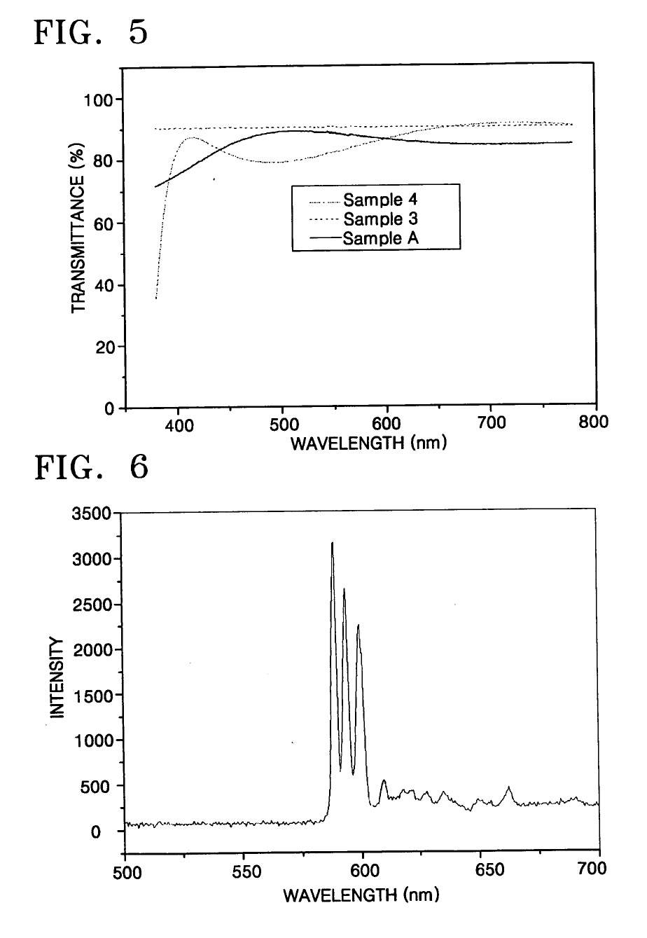

The transmittances of Samples 3 and 4 are shown in FIG. 5. Referring to FIG. 5, the transmittance of Sample 3, which was heated in a hydrogen atmosphere, was greater than the transmittance of Sample 4, which was heated in air, over the entire range of wavelengths.

### EVALUATION EXAMPLE 2

### Evaluation of Light Emission Characteristics

To indirectly evaluate a light emission characteristic of Sample 1, the photoluminescence of SnO₂ powder doped with 1 mole % of Eu₂O₃ was measured. The SnO₂ powder (“Powder 1”) was obtained by doping SnO₂ powder with 1 mole % of Eu2O3 powder and heating it at 1600 C.° for 2 hours. The photoluminescence was measured using a photon counting spectrometer (ISS PCI) at 500 W. The light emission characteristics of Powder 1 are shown in FIG. 6. FIG. 6 is a graph of photoluminescence in a UV excitation condition at 365 nm. Referring to FIG. 6, a high peak appears at 592 nm, indicating the emission of red light.

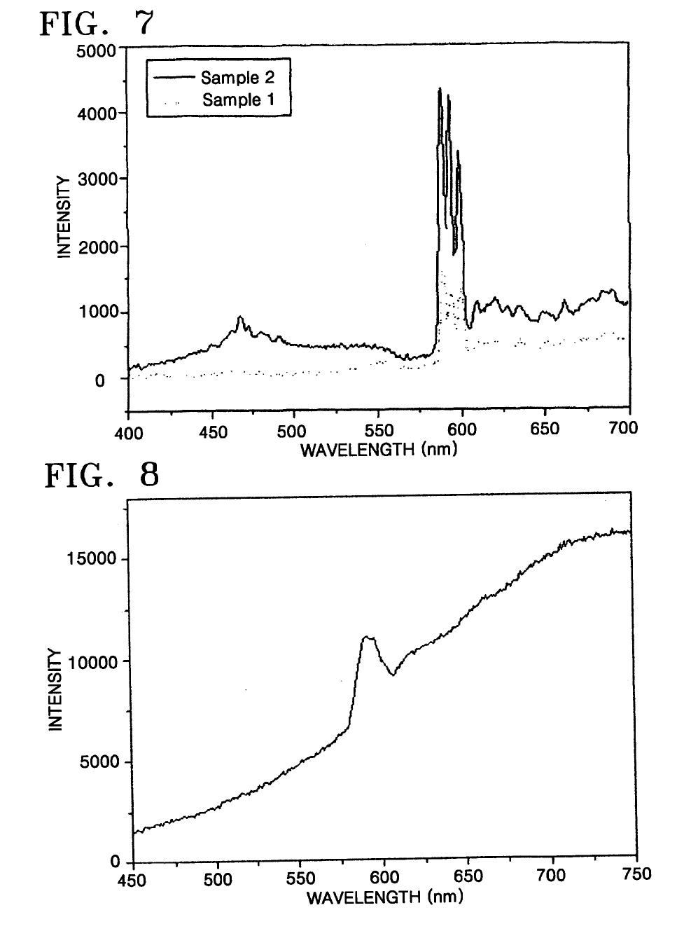

The photoluminescence of Samples 1 and 2 were directly measured. The results are shown in FIG. 7. FIG. 7 is a graph of light emission characteristic in a UV excitation condition at 330 nm. Referring to FIG. 7, a high peak appears at 592 nm, indicating the emission of red light.

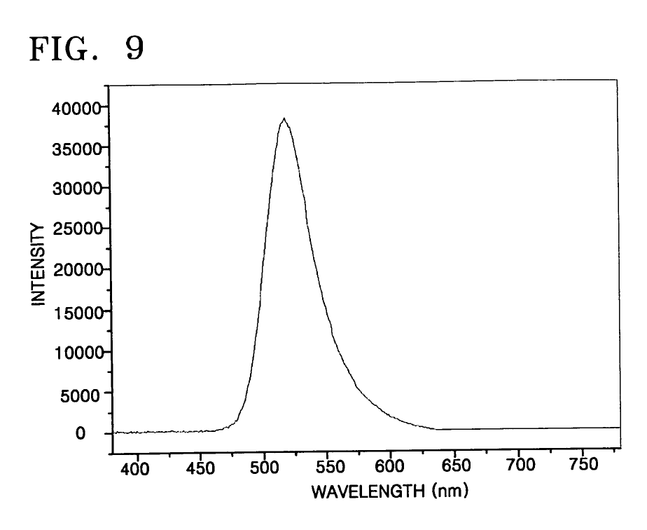

The cathodluminescence of Sample 1 was measured as another light emission characteristic. The results are shown in FIG. 8. The cathodluminescence was measured using a Kimball Physics FRA-2X1-2/EGPS-2X1 electron gun (E-gun) system at a beam current density of 70 μA/cm2 and an excitation energy of 500-1000 eV. Referring to FIG. 8, although background appears, a peak appeared near 592 nm, indicating that Sample 1 emits red light.

To evaluate the light emission characteristic of Sample 1, the cathodluminescence was measured using the same apparatus described as above. The results are shown in FIG. 9. Referring to FIG. 9, a high peak appears at 520 nm, indicating that Sample 3 emits green light.

As described above, in an electron emission device according to the present invention, a transparent light-emitting conductive layer that can induce additional light emission using excess electrons emitted from an electron emission region which did not participate in the light emission in a fluorescent layer is used, resulting in improvements in color purity, reproduction range of colors, brightness, and color rendering properties. An electron emission device according to the present invention can be manufactured using the transparent light-emitting conductive layer. Furthermore, an electron emission display device and a back-light unit with improved reliability can be manufactured using the transparent light-emitting conductive layer, and a flat display device with improved reliability can be manufactured using the back-light unit.

While the present invention has been particularly shown and described with reference to exemplary embodiments thereof, it will be understood by those of ordinary skill in the art that various modifications in form and detail can be made therein without departing from the spirit and scope of the present invention as defined by the following claims.

What is claimed is:

1. A transparent light-emitting conductive layer comprising a Transparent Conductive Oxide (TCO) and a dopant.

2. The transparent light-emitting conductive layer according to claim 1, wherein the TCO comprises a material selected from a group consisting of ZnO, SnO₂, In₂O₃, ZnGa₂O₄, CdSnO₃, and SrTiO₃.

3. The transparent light-emitting conductive layer according to claim 1, wherein the dopant is adapted to act as activator ions and comprises at least one material selected from a group consisting of Eu, Tb, Mn, Gd, Sm, Ho, Tm, Dy, Pr, Ce, Nd, Cu, Ag, and Mg.

4. The transparent light-emitting conductive layer according to claim 1, wherein the content of the dopant is in a range of 0.005-15 mole % based on the content of the TCO.

5. The transparent light-emitting conductive layer according to claim 1, wherein the transparent light-emitting conductive layer comprises deposited and then heated TCO doped with the dopant on a substrate.

6. The transparent light-emitting conductive layer according to claim 5, wherein the TCO is adapted to be heated by a furnace or rapid heating method.

7. The transparent light-emitting conductive layer according to claim 5, wherein the TCO is adapted to be heated at a temperature of 500-1200 C.°.

8. The transparent light-emitting conductive layer according to claim 5, wherein the TCO is adapted to be heated in a hydrogen atmosphere.

9. An electron emission device, comprising:
a front substrate;
a first electrode arranged on the front surface, the first electrode having a transparent light-emitting conductive layer including a Transparent Conductive Oxide (TCO) and a dopant;
a fluorescent layer arranged on the first electrode;
a rear substrate spaced apart from and facing the front substrate;
an electron emission region arranged on the rear substrate; and
a second electrode adapted to control electron emission in the electron emission region.

10. The electron emission device according to claim 9, wherein the TCO comprises a material selected from a group consisting of ZnO, SnO₂, In₂O₃, ZnGa₂O₄, CdSnO₃, and SrTiO₃.

11. The electron emission device according to claim 9, wherein the dopant is adapted to act as activator ions and comprises at least one material selected from a group consisting of Eu, Tb, Mn, Gd, Sm, Ho, Tm, Dy, Pr, Ce, Nd, Cu, Ag, and Mg.

12. The electron emission device according to claim 9, wherein the content of the dopant is in a range of 0.005-15 mole % based on the content of the TCO.

13. The electron emission device according to claim 9, wherein the electron emission region includes carbon nano-tubes.

14. The electron emission device according to claim 9, wherein the TCO comprises a material selected from a group consisting of ZnO, SnO₂, In₂O₃, ZnGa₂O₄, CdSnO₃, and SrTiO₃, and the dopant is adapted to act as activator ions and comprises at least one material selected from a group consisting of Eu, Tb, Mn, Gd, Sm, Ho, Tm, Dy, Pr, Ce, Nd, Cu, Ag, and Mg.

15. A back-light unit, comprising:
a front substrate;
a first electrode arranged on the front substrate;
a fluorescent layer arranged on the first electrode, the first electrode having a transparent light-emitting conductive layer including a Transparent Conductive Oxide (TCO) and a dopant;
a rear substrate spaced apart from and facing the front substrate;
an electron emission region arranged on the rear substrate; and
a second electrode adapted to control electron emission in the electron emission region.

16. A flat display device, comprising:
a back-light unit including:
a front substrate;
a first electrode arranged on the front substrate;
a fluorescent layer arranged on the first electrode, the first electrode having a transparent light-emitting conductive layer including a Transparent Conductive Oxide (TCO) and a dopant;
a rear substrate spaced apart from and facing the front substrate;
an electron emission region arranged on the rear substrate; and
a second electrode adapted to control electron emission in the electron emission region; and
a display panel arranged in front of the back-light unit and including a light receiving device adapted to reproduce images by controlling the light emitted from the back-light unit.
